(19) United States
(12) Patent Application Publication
(10) Pub. No.: US 2018/0012148 A1
(43) Pub. Date: Jan. 11, 2018

(54) VEHICLE BOOKING SYSTEM AND METHOD THEREOF

(71) Applicant: GRABTAXI HOLDINGS PTE LTD, Singapore (SG)

(72) Inventors: Ryan LAW HUI HORNG, Singapore (SG); Corey SCOTT, Singapore (SG)

(21) Appl. No.: 15/550,089

(22) PCT Filed: Feb. 10, 2015
(86) PCT No.: PCT/SG2015/000037

§ 371 Date: Aug. 10, 2017

(51) Int. Cl. G06Q 10/02; G06F 17/30

(52) U.S. Cl. CPC G06Q 10/02; G06F 17/30964

(57) ABSTRACT

The present invention relates to a vehicle booking system having a server configured to communicate with a plurality of vehicles, such that the server is configured to receive and store a plurality of vehicle booking requests in a vehicle booking requests database and the server is configured to identify and filter a plurality of undesirable vehicle booking requests from the plurality of vehicle booking requests to obtain a plurality of desirable vehicle booking requests and transmit the plurality of desirable vehicle booking requests to the plurality of vehicles. Further, the present invention provides a method of booking a vehicle.

### TECHNICAL FIELD

The present invention relates to a vehicle booking system and a method thereof.

### BACKGROUND

Vehicles for hire, e.g. taxis/cabs, privately own vehicles, are commonly seen in most countries. Such vehicles may be flagged down by a passenger along the road or booked by a passenger over a communication device, e.g. phone.

To pre-booked a vehicle, e.g. taxi, a passenger would contact, usually, a company, e.g. taxi company, that manages the booking of a plurality of taxis and a taxi may be dispatched to the passenger.

In some countries, the passenger may dial in to the taxi company using a phone and either speak to a telephone operator and/or a machine operated booking system. By booking a taxi over the phone, the passenger relays a booking request to the taxi company. A manual or automatic system may be used to broadcast the booking request to the taxis. Taxis that are in the proximity of the booking request, i.e. the location of the passenger, may respond to the taxi company to bid for the booking request, often via a radio communication system. From the plurality of biddings submitted by the taxis, the taxi company may manually select the taxi to assign the booking request to. Often the selection process is performed at the discretion and experience of the operator and the taxi selected may not be the taxi that is closest to the passenger. Such a system may not be efficient and is unable to provide optimal service to the passenger.

In some other countries, a Global Positioning System (GPS) or General Packet Radio Service (GPRS) system may be used to detect the location of taxis. For such a taxi location system, the passenger may dial in to the taxi company to submit a booking request which consist of the pick-up location of the passenger. The taxi location system is able to locate taxis in close proximity to the passenger and automatically broadcast the booking request to taxis in the vicinity of the passenger. The booking request, which usually includes information on the pick-up and drop-off location, may be displayed on devices installed in the taxis. Taxi drivers would have to look at the screen to read the booking request before they decide if they are able to bid for the booking request.

Often, the taxi drivers would need to read the booking requests while driving. For systems which display a list of booking requests on the screen, the taxi driver would need to spend time looking at the screen. Also, often, the booking requests on the screen may not be of interest or relevant to the taxi driver. As such, the taxi driver would have to spend time reading the booking request regardless the relevancy of the booking request so that they would not miss out on any relevant booking request. It would be clear that the longer the taxi drivers take their eyes off the road, the higher the probability of the taxi meeting with an accident on the road.

It is thus an object of the present invention to try to alleviate the aforementioned problems.

### SUMMARY

Accordingly to various embodiments, the present invention provides a vehicle booking system. The vehicle booking system includes a server configured to communicate with a plurality of vehicles, such that the server is configured to receive and store a plurality of vehicle booking requests in a vehicle booking requests database; and such that the server is configured to identify and filter a plurality of undesirable vehicle booking requests from the plurality of vehicle booking requests to obtain a plurality of desirable vehicle booking requests and transmit the plurality of desirable vehicle booking requests to the plurality of vehicles.

Accordingly to various embodiments, the plurality of undesirable vehicle booking requests may be identified based on booking request data of the plurality of vehicle booking requests.

Accordingly to various embodiments, the booking request data may include journey data, wherein the plurality of undesirable vehicle booking requests are identified based on the journey data of the plurality of vehicle booking requests.

Accordingly to various embodiments, the journey data may include pick-up location and/or drop-off location of a user.

Accordingly to various embodiments, the booking request data may include user data, such that the plurality of undesirable vehicle booking requests are identified based on user data of the plurality of vehicle booking requests.

Accordingly to various embodiments, the user data of each of the plurality of vehicle booking requests may include a user identification key.

Accordingly to various embodiments, the plurality of undesirable vehicle booking requests may include a duplicate vehicle booking request of an original vehicle booking request.

Accordingly to various embodiments, the duplicate vehicle booking request may include the same pick-up location and/or drop-off location as the original vehicle booking request.

Accordingly to various embodiments, the duplicate vehicle booking request may include the same user identification key as the original vehicle booking request.

Accordingly to various embodiments, the duplicate vehicle booking request and the original vehicle booking request may be made within a specified time period.

Accordingly to various embodiments, the server may be configured to identify a plurality of excluded vehicles from the plurality of vehicles to obtain a plurality of selected vehicles, wherein the plurality of desirable vehicle booking requests are transmitted to the plurality of selected vehicles but not the plurality of excluded vehicles.

Accordingly to various embodiments, the plurality of excluded vehicles may include a rejecting vehicle, such that the rejecting vehicle rejects at least one of the plurality of desirable vehicle booking requests, such that the rejecting vehicle may be excluded from receiving the at least one of the plurality of desirable vehicle booking requests.

Accordingly to various embodiments, the plurality of excluded vehicles may include an ignoring vehicle, such that the ignoring vehicle ignores at least one of the plurality of desirable vehicle booking requests, such that the ignoring vehicle may be excluded from receiving the at least one of the plurality of desirable vehicle booking requests.

Accordingly to various embodiments, the ignoring vehicle may be considered to ignore the at least one of the plurality of desirable booking requests when the ignoring vehicle ignores the at least one of the plurality of desirable booking requests beyond a specified time period from the time when the at least one of the plurality of desirable booking requests are transmitted to the ignoring vehicle.

Accordingly to various embodiments, the transmission of the at least one of the plurality of desirable booking requests to the ignoring vehicle may be terminated when the ignoring vehicle ignores the plurality of desirable booking requests beyond a specified number of times.

Accordingly to various embodiments, ignoring the plurality of desirable booking requests may include not submitting the bidding request or decline instruction for the at least one of the plurality of desirable booking requests.

Accordingly to various embodiments, the server transmits the at least one of the plurality of desirable vehicle booking requests to the ignoring vehicle after a specified period of block out time.

Accordingly to various embodiments, the plurality of excluded vehicles may include an occupied vehicle, wherein the occupied vehicle may include a vehicle having a passenger on board.

Accordingly to various embodiments, the occupied vehicle may be occupied when a distance travelled by the occupied vehicle from a pick-up location of the passenger is shorter than a specified proportion of the calculated distance between the pick-up location and a drop-off location.

Accordingly to various embodiments, the occupied vehicle is occupied when a time period that the passenger is on board the occupied vehicle is shorter than a specified proportion of estimated travel time to travel from the pick-up location to the drop-off location.

Accordingly to various embodiments, the server may be configured to maintain a specified number of the plurality of selected vehicles, such that the server is configured to transmit the plurality of desirable vehicle booking requests to the plurality of excluded vehicles when the plurality of selected vehicles are less than the specified number.

Accordingly to various embodiments, the present invention provide a method for booking a plurality of vehicles, the method includes receiving and storing a plurality of vehicle booking requests in a vehicle booking requests database, identifying and filtering a plurality of undesirable vehicle booking requests from the plurality of vehicle booking requests to obtain a plurality of desirable vehicle booking requests and transmitting the plurality of desirable vehicle booking requests to a plurality of vehicles.

Accordingly to various embodiments, the plurality of undesirable vehicle booking requests may be identified based on booking request data of the plurality of vehicle booking requests.

Accordingly to various embodiments, the booking request data may include journey data, such that the plurality of undesirable vehicle booking requests are identified based on the journey data of the plurality of vehicle booking requests.

Accordingly to various embodiments, the journey data may include pick-up location and/or drop-off location.

Accordingly to various embodiments, the booking request data may include user data, such that the plurality of undesirable vehicle booking requests are identified based on user data of the plurality of vehicle booking requests.

Accordingly to various embodiments, the user data of each of the plurality of vehicle booking requests may include a user identification key.

Accordingly to various embodiments, the plurality of undesirable vehicle booking requests may include a duplicate vehicle booking request of an original vehicle booking request.

Accordingly to various embodiments, the plurality of undesirable vehicle booking requests may include a duplicate vehicle booking request of an original vehicle booking request.

Accordingly to various embodiments, the duplicate vehicle booking request may include the same pick-up location and/or drop-off location as the original vehicle booking request.

Accordingly to various embodiments, the duplicate vehicle booking request may include the same user identification key as the original vehicle booking request.

Accordingly to various embodiments, the duplicate vehicle booking request and the original vehicle booking request may be made within a specified time period.

Accordingly to various embodiments, the method may further include identifying a plurality of excluded vehicles from the plurality of vehicles to obtain a plurality of selected vehicles, such that the plurality of desirable vehicle booking requests may be transmitted to the plurality of selected vehicles but not the plurality of excluded vehicles.

Accordingly to various embodiments, the plurality of excluded vehicles may include a rejecting vehicle, such that the rejecting vehicle rejects at least one of the plurality of desirable vehicle booking requests, such that the rejecting vehicle may be excluded from receiving the at least one of the plurality of desirable vehicle booking requests.

Accordingly to various embodiments, the plurality of excluded vehicles may include an ignoring vehicle, such that the ignoring vehicle ignores the plurality of desirable booking requests, such that the ignoring vehicle may be excluded from receiving the at least one of the plurality of desirable vehicle booking requests.

Accordingly to various embodiments, the ignoring vehicle may be considered to ignore the at least one of the plurality of desirable booking requests when the ignoring vehicle ignores the at least one of the plurality of desirable booking requests beyond a specified time period the time from when the at least one of the plurality of desirable booking requests are transmitted to the ignoring vehicle.

Accordingly to various embodiments, the transmission of the at least one of the plurality of desirable booking requests to the ignoring vehicle may be terminated when the ignoring vehicle ignores the plurality of desirable booking requests beyond a specified number of times.

Accordingly to various embodiments, ignoring the plurality of desirable booking requests may include not submitting the bidding request for the at least one of the plurality of desirable booking requests.

Accordingly to various embodiments, the method may further include transmitting the at least one of the plurality of desirable vehicle booking requests to the ignoring vehicle after a specified period of block out time.

Accordingly to various embodiments, the plurality of excluded vehicles may include an occupied vehicle, such that the occupied vehicle may include a vehicle having a passenger on board.

Accordingly to various embodiments, the occupied vehicle is occupied when a distance travelled by the occupied vehicle from a pick-up location of the passenger is shorter than a specified proportion of the calculated distance between the pick-up location and a drop-off location of the passenger.

Accordingly to various embodiments, the occupied vehicle is occupied when a time period that the passenger is on board the occupied vehicle is shorter than a specified proportion of estimated travel time to travel from the pick-up location to the drop-off location of the passenger.

Accordingly to various embodiments, may further include maintaining a specified number of the plurality of selected vehicles, such that the plurality of desirable vehicle booking requests are transmitted to the plurality of excluded vehicles when the plurality of selected vehicles are less than the specified number.

The present invention provides a vehicle booking, system and method thereof that improve the relevancy and accuracy of the booking requests to the taxi driver as the present invention improves the decision making process of the taxi drivers in the selection process of the plurality vehicle booking requests. In this way, the time required for the taxi drivers to read the screen would be reduced and hence the probability of meeting with an accident on the road would correspondingly be reduced.

Further, the present invention may indirectly reduce the waiting time of a passenger as the time taken to assign a taxi to the passenger is reduced due to the increase in relevancy in the booking requests. In addition, by increasing the relevancy, the chance of bidding success, hence the time taken to bid and win a booking request may be reduced. Correspondingly, the waiting time of the passenger may be reduced.

### BRIEF DESCRIPTION OF THE DRAWINGS

FIG. 1 shows an exemplary embodiment of a vehicle booking system;

FIG. 1A shows an exemplary embodiment of a server;

FIG. 2 shows an exemplary embodiment of one of the plurality of vehicle booking devices;

FIG. 3 shows an exemplary embodiment of a vehicular device;

FIG. 4 shows an exemplary method for booking a vehicle;

FIG. 5 shows an exemplary method for booking a vehicle;

FIG. 6 shows an identifying step of the method in FIG. 5;

FIG. 7 shows an identifying step of the method in FIG. 6;

FIG. 8 shows an identifying step of the method in FIG. 7;

FIG. 9 shows an identifying step of the method in FIG. 6;

FIG. 10 shows an identifying step in FIG. 5;

FIG. 10A shows an identifying step in FIG. 5;

FIG. 11 shows further steps of the method in FIG. 5.

### DETAILED DESCRIPTION

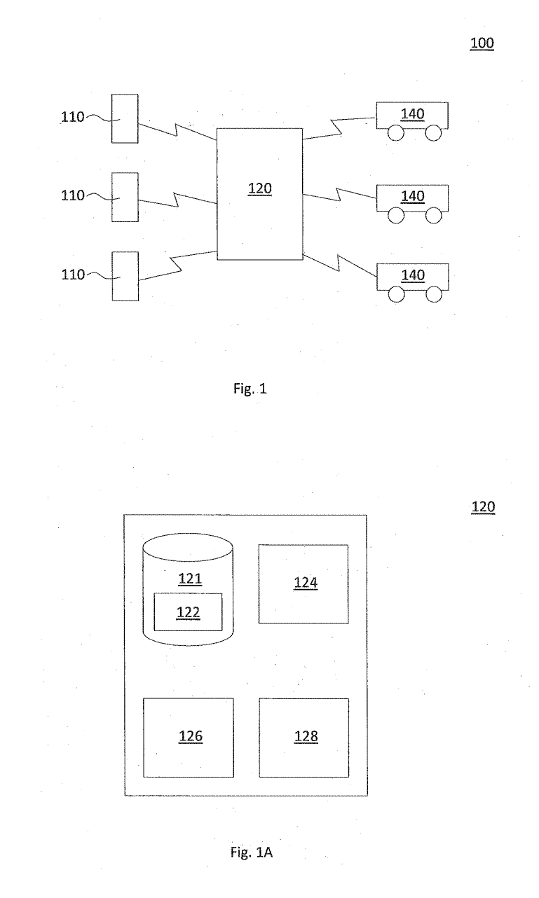

FIG. 1 shows a vehicle booking system 100 configured for booking vehicles. Vehicle booking system 100 may include a server 120 in communication with a plurality of vehicle booking devices 110 and a plurality of vehicles 140.

Referring to FIG. 1A, the server 120 may include a storage media 121 configured to store a vehicle booking request database 122, whereby the vehicle booking request database 122 is configured to store a plurality of vehicle booking requests, a processor 124 configured to process the plurality of vehicle booking requests, a receiver 126 configured to receive data from the plurality of vehicle booking devices 110 and the plurality of vehicles 140 and a transmitter 128 configured to transmit data to the plurality of vehicle booking devices 110 and the plurality of vehicles 140.

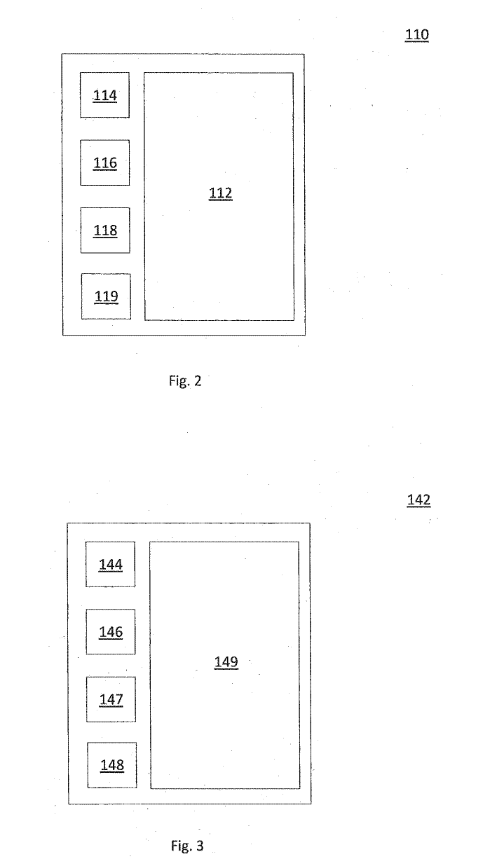

FIG. 2 shows an exemplary embodiment of one of the plurality of vehicle booking devices 110. Plurality of vehicle booking devices 110 are configured to generate a plurality of vehicle booking requests from a plurality of users. Plurality of vehicle booking devices 110 may each include a user interface 112 configured to receive user input from a user, a transmitter 114 configured to transmit data to the server 120, a receiver 116 configured to receive data from the server 120, and a processor 118 configured to process the user input and generate the plurality of vehicle booking requests. Each of the plurality of vehicle booking devices 110 may include a location positioning module 119 configured to determine the location of the vehicle booking device 110. Plurality of vehicle booking devices 110 may be a mobile device, e.g. a smart phone, laptop. Plurality of vehicle booking devices 110 may have a software application (“app”) configured to receive the user input and generate the plurality of vehicle booking requests.

Server 120 is configured to communicate with the plurality of vehicles 140. Server 120 is configured to receive and store the plurality of vehicle booking requests in the vehicle booking database 122. Server 120 is configured to identify and filter a plurality of undesirable vehicle booking requests from the plurality of vehicle booking requests to obtain a plurality of desirable vehicle booking requests and transmit the plurality of desirable vehicle booking requests to the plurality of vehicles 140.

FIG. 3 shows an exemplary embodiment of a vehicular device 142. Plurality of vehicles 140 may each include the vehicular device 142 configured to communicate with the server 120. Vehicular device 142 may include a receiver 144 configured to receive data from the server 120, a transmitter 146 configured to transmit data to the server 120, a processor 148 configured to process the plurality of booking requests, and a display 149 configured to display data, e.g. the plurality of vehicle booking requests. Display 149 may be configured to include a user interface configured to receive a driver's input. Plurality of vehicular devices 142 may each include a location positioning module 147 configured to locate the position of the plurality of vehicular devices 142, hence the position of the plurality of vehicles 140.

Plurality of vehicle booking devices 110 may be configured to receive user input from a plurality of users to book the plurality of vehicles 140. User input may include booking request data of each of the plurality of users. Plurality of users may enter booking request data into the plurality of vehicle booking devices 110. Booking request data may be entered via the user interface 112 of the vehicle booking device 110. Booking request data may include at least one of an identification key of a user, a drop-off location where the user may be picked up by at least one of the plurality of vehicles 140 and a drop-off location where the user may be dropped off by the at least one of the plurality of vehicles 140. When a booking request is made, the user may enter the identification key, the pick-up location and the drop-off location. Pick-up location of the plurality of users may be automatically obtained from the plurality of vehicle booking devices 110 using the location positioning module of the location of the vehicle booking device. Identification key of a user may be stored in each of the plurality of vehicle booking devices 110 and automatically be included in the booking request data when the plurality of vehicle booking requests are generated. Plurality of users may each obtain an identification key from the server when the plurality of users sign up for a booking account with the server. Pick-up location and the drop-off location may be coordinates of a country's coordinate system e.g. latitude and longitude.

Upon entering the booking request data into the plurality of vehicle booking devices 110, the plurality of vehicle booking devices 110 may generate the plurality of vehicle booking requests. Plurality of vehicle booking requests may be transmitted to the server 120.

Server 120 may be configured to identify the plurality of undesirable vehicle booking requests and the plurality of desirable vehicle booking requests from the plurality of vehicle booking requests. Server 120 may be configured to filter the undesirable vehicle booking requests from the plurality of vehicle booking requests. Server 120 may be configured to transmit the desirable vehicle booking requests to the plurality of vehicles 140. A undesirable vehicle booking request may be a vehicle booking request that is not transmitted to the plurality of vehicles. Desirable vehicle booking request is a vehicle booking request that would be transmitted to the plurality of vehicles.

Undesirable vehicle booking requests may include a duplicate vehicle booking request of an original vehicle booking request. For the server 120 to identify undesirable vehicle booking requests, the server 120 may be configured to identify duplicated vehicle booking requests. Plurality of undesirable vehicle booking requests may be identified based on booking request data of the plurality of vehicle booking requests. Duplicated vehicle booking requests may be vehicle booking requests with the same booking request data such that the duplicate vehicle booking request may have the same booking request data as the original vehicle booking request. Original vehicle booking request may be the first vehicle booking request made by a user. Duplicate vehicle booking request may be a subsequent vehicle booking request made by the same user and having the same booking request data.

Booking request data may include journey data, such that the plurality of undesirable vehicle booking requests may be identified based on the journey data of the plurality of vehicle booking requests. Server 120 may identify the plurality of undesirable vehicle booking requests by analyzing the journey data of the plurality of vehicle booking requests. Server 120 may identify the plurality of duplicated vehicle booking request from the plurality of vehicle booking requests based on the same journey data. Server 120 may classify the plurality of duplicated vehicle booking requests as the plurality of undesirable vehicle booking requests.

Journey data may include pick-up location and/or drop-off location of a user. Duplicate vehicle booking request may have the same pick-up location and/or drop-off location as the original vehicle booking request. Server 120 may be configured to identify the plurality of vehicle booking requests with same pick-up location and/or drop-off location. While it is understood that duplicate vehicle booking requests have the same pick-up location and drop-off location, the pick-up locations of the duplicated vehicle booking requests may be of close proximity to each other and need not be exactly the same. Similarly, the drop-off locations of the duplicated vehicle booking requests may be of close proximity to each other and need not be exactly the same. Server 120 may classify the plurality of vehicle booking requests with the same pick-up location and/or drop-off location as duplicate vehicle booking requests.

Booking request data may include user data, such that the plurality of undesirable vehicle booking requests may be identified based on user data of the plurality of vehicle booking requests. Server 120 may identify the plurality of duplicate vehicle booking requests based on the user data of the plurality of vehicle booking requests. Server 120 may classify the plurality of duplicated vehicle booking requests as the plurality of undesirable vehicle booking requests. User data of each of the plurality of vehicle booking requests may include the user identification key. Duplicate vehicle booking request may include the same user identification key as the user identification key of the original vehicle booking request. Server 120 may identify the plurality of duplicated vehicle booking request based on the user identification key. Server 120 may classify the plurality of vehicle booking requests with the same user identification keys as duplicate vehicle booking requests.

Server 120 may identify the plurality of undesirable vehicle book requests based on at least one of the journey data or the user data. Server 120 may identify the plurality of undesirable vehicle booking requests based on at least one of pick-up location, drop-off location, or user identification key.

Server 120 may identify the duplicate vehicle booking request and the original vehicle booking request that are made within a specified time period. Server 120 may identify a duplicated vehicle booking request and an original vehicle booking request that are generated within a specified time period, e.g. 1 min, 5 mins, 10 mins. As such, the server 120 may identify such vehicle booking request as an undesirable vehicle booking request. Vehicle booking device may not generate a vehicle booking request by a user if the vehicle booking request is made by the same user and/or with the same journey data, within the specified period of time from an earlier vehicle booking request.

Server 120 may be configured to process the plurality of desirable vehicle booking requests to determine booking parameters of each of the plurality of desirable vehicle booking requests. Booking parameters may include the distance between the pick-up location and the drop-off location, the estimated time required to travel from the pick-up location and the drop-off location, etc. Based on the booking parameters, the server 120 may identify the plurality of vehicles 140 which are most suitable for each of the plurality of desirable booking requests and transmit the plurality of desirable vehicle booking requests to each of the plurality of vehicles 140. Server 120 may select the plurality of vehicles based the driver's data, e.g. driver's points, driver's credit balance.

Vehicle booking system 100 may increase the relevance of the plurality of vehicle booking requests to the plurality of vehicles 140 by transmitting the plurality of vehicle booking requests to relevant plurality of vehicles. Server 120 may be configured to identify a plurality of excluded vehicles from the plurality of vehicles to obtain a plurality of selected vehicles so that the plurality of desirable vehicle booking requests can be transmitted to the plurality of selected vehicles but not the plurality of excluded vehicles. Plurality of selected vehicles may be vehicles that are most relevant to the plurality of vehicle booking requests. Plurality of excluded vehicles may be vehicles that are the least relevant to the plurality of vehicle booking requests. Server 120 may filter the plurality of vehicles to select the plurality of selected vehicles suitable for the plurality of desirable vehicle booking requests. Identification of the plurality of excluded vehicles may be based on the response from the plurality of vehicles 140 as will be explained below.

Plurality of excluded vehicles may include a rejecting vehicle. Rejecting vehicle may be a vehicle which rejects at least one of the plurality of desirable vehicle booking requests. Rejecting vehicle may be excluded from receiving the at least one of the plurality of desirable vehicle booking requests. Server 120 may transmit the plurality of desirable vehicle booking requests to the plurality of vehicles 140. A vehicle may reject or decline a desirable vehicle booking request and the vehicular device 142 of the server 120 would transmit a reject signal for the rejected vehicle booking request to the server 120. Server 120 may be configured to store the reject signal, data of the rejecting vehicle and/or the rejected vehicle booking request in a reject database. Subsequently, the server 120 would identify the rejecting vehicle and classify the rejecting vehicle as an excluded vehicle for the rejected vehicle booking request. Consequently, the server 120 would not transmit the rejected vehicle booking request to the rejecting vehicle again. In this way, the rejecting vehicle would not receive the rejected vehicle booking request as the rejected vehicle booking request would be an irrelevant vehicle booking request. Therefore, the driver of the rejecting vehicle would not need to spend time to look at the rejected vehicle booking request.

Plurality of excluded vehicles may include an ignoring vehicle. Ignoring vehicle may be a vehicle which ignores at least one of the plurality of desirable vehicle booking requests. Ignoring vehicle may be excluded from receiving the at least one of the plurality of desirable vehicle booking requests. Server 120 may transmit the plurality of desirable vehicle booking requests to the plurality of vehicles 140. A vehicle may ignore a desirable vehicle booking request and the vehicular device 142 of the server 120 would transmit an ignore signal for the ignored vehicle booking request to the server 120. Server 120 may be configured to store the ignore signal, data of the ignoring vehicle and/or the ignore vehicle booking request in a ignore database. Server 120 may consider the ignoring vehicle to ignore the at least one of the plurality of desirable booking requests when the ignoring vehicle ignores the at least one of the plurality of desirable booking requests beyond a specified time period from the time when the at least one of the plurality of desirable booking requests are transmitted to the ignoring vehicle. Ignoring vehicle may be considered as ignoring the at least one of the plurality of desirable booking requests when the vehicle receiving the desirable vehicle booking request does not respond, i.e. bid or decline, within a specified time period, e.g. 15 secs, 20 secs, 30 secs etc., from the time of transmission. Subsequently, the server 120 would classify the ignoring vehicle to be an excluded vehicle for the ignored vehicle booking request and would not transmit the ignored vehicle booking request to the ignoring vehicle again. In this way, the ignoring vehicle would not receive the ignored vehicle booking request as the ignored vehicle booking request would be an irrelevant vehicle booking request and the driver of the ignoring vehicle would not need to spend time to look at the ignored vehicle booking request.

However, the server 120 may be configured to transmit the ignored vehicle booking request even though the ignoring vehicle has been classified as an excluded vehicle. As the ignoring vehicle may not have ignored the vehicle booking request intentionally, e.g. due to driving condition, the server 120 may transmit the ignored vehicle booking request again to provide the ignoring vehicle another opportunity to bid for the vehicle booking request. Server 120 may be configured to allow a specified number to times that the ignoring vehicle can ignore the vehicle booking request, e.g. twice, three times, four times. Transmission of the at least one of the plurality of desirable booking requests to the ignoring vehicle may be terminated when the ignoring vehicle ignores the plurality of desirable booking requests beyond the specified number of times. Ignoring vehicle may be considered to ignore the plurality of desirable booking requests if the ignoring vehicle does not submit the bidding request or decline instructions for the at least one of the plurality of desirable booking requests. Ignoring vehicle may also be considered to ignore the plurality of desirable booking requests if the server 120 does not receive a response from the vehicle, e.g. if the vehicle does not bid or decline the vehicle booking request. In certain circumstances, the vehicle may have responded to the vehicle booking request but the response may not have been transmitted to the server 120 due to communication error. As such, the server 120 may be configured to allow a transmission of the desirable vehicle booking request more than one time to reduce the occurrence of such communication error. Server 120 may transmit the at least one of the plurality of desirable vehicle booking requests to the ignoring vehicle after a specified period of block out time. Server 120 may re-transmit the desirable vehicle booking request after a specified period of block out time, e.g. 30 secs, 1 min, from the time the server 120 determines that the desirable vehicle booking request has been ignored.

Plurality of excluded vehicles may include an occupied vehicle. Occupied vehicle may include a vehicle having a passenger on board. Server 120 may not transmit the plurality of desired vehicle booking requests to an occupied vehicle. When a vehicle picks up a passenger, the vehicle 140 may update the status of the vehicle to “occupied” by inputting the status into the vehicular device 142 of the vehicle 140.

Status of the vehicle may be determined by the server 120, i.e. server-based, or from the vehicle, i.e. vehicle-based. For server-based determination, the occupied vehicle may be considered occupied when a distance travelled by the occupied vehicle from a pick-up location of the passenger is shorter than a specified proportion of the calculated distance between the pick-up location and a drop-off location and/or when a time period that the passenger is on board the occupied vehicle is shorter than a specified proportion of estimated travel time to travel from the pick-up location to the drop-off location. Server 120 may calculate the distance and/or estimated travel time required for the vehicle to travel between the pick-up location and the drop-off location of a user along a pre-determined route. Server 120 may be configured to classify the vehicle as an occupied vehicle when the distance travelled (distance-based) or the elapsed travel time (time-based) of the occupied vehicle is shorter than the a specified or pre-determined, distance and/or time. Thee distance travelled by the vehicle may be obtained from the vehicular device 142 when the vehicular device 142 transmits its location to the server 120. The elapsed travel time may be calculated by the server 120 based on the time the user is picked up or when the status of the occupied vehicle is changed to “occupied”. The specified proportion of the calculated distance may be 90%, 95% of the calculated distance. The specified proportion of calculated time may be 90%, 95% of the calculated time.

For vehicle-based determination, the server 120 may receive the status of the vehicle transmitted from the vehicular device 142 of the vehicle 140, which may be controlled by the driver of the vehicle 140, i.e. when the driver toggles a status displayed on the vehicular device 142 from “available” to “occupied”. Server 120 may be configured to consider the server-based determination over the vehicle-based determination. Server 120 may be configured to consider the server-based determination and not the vehicle-based determination. Server 120 may be configured to consider the time-based determination over the distance-based determination and vice-versa. Server 120 may be configured to consider a pick-up travel time, i.e. the time required for the vehicle to travel from its booked location to the pick-up location, when using the time-based determination. Booked location may a location where the vehicle is booked, i.e. when the vehicle receives a confirmation of a bidding request for a vehicle booking request. When determining the status of a vehicle, the server 120 may be configured to consider the pick-up travel time and the estimated travel time of the vehicle. In this way, a vehicle may be prevented from amending the status from “occupied” to “available” before reaching the drop-off location so as to avail itself to receive the plurality of vehicle booking requests, i.e. switch from an excluded vehicle to a selected vehicle in the server 120. By preventing such an advance amendment of the status, the vehicle booking system 100 may be able to improve the accuracy of the booking requests and consequently, reduce the wait time of the passenger.

Upon identifying the plurality of selected vehicles, the server 120 is configured to transmit the plurality of desirable vehicle booking requests to the plurality of selected vehicles. Plurality of selected vehicles may choose to bid or decline for the plurality of vehicle booking requests. Plurality of selected vehicles may ignore the plurality of desirable vehicle booking requests, intentionally or accidentally. Server 120 may be configured to monitor the number of the plurality of selected vehicles. Server 120 may be configured to maintain a specified number of the plurality of selected vehicles. Server 120 may be configured to transmit the plurality of desirable vehicle booking requests to the plurality of excluded vehicles when the plurality of selected vehicles are less than the specified number. Server 120 may be configured to determine the specified number based on the number of vehicle booking requests received by the server 120. Although, the plurality of desirable vehicle booking requests may not be very relevant to the plurality of excluded vehicles, by transmitting the plurality of desirable vehicle booking requests to the plurality of excluded vehicles may improve the chance of a passenger booking a vehicle when the number of selected vehicles is lower than the specified number of the plurality of selected vehicles. E.g. if there are only a small number of vehicles in the vicinity of the passenger. Server 120 may be configured to transmit the plurality of vehicle booking requests to the plurality of selected vehicles without first filtering the plurality of vehicle booking requests to extract the plurality of desirable vehicle booking requests.

Upon receiving the plurality of vehicle booking requests, each of the plurality of vehicles 140 may bid for at least one of the plurality of vehicle booking requests by submitting a bidding request to the server 120. A plurality of bidding request may be submitted via the vehicular device 142 in the vehicle 140 to the server 120. Server 120 may be configured to determine one of the plurality of bidding requests as the winner for the vehicle booking request based on certain criteria, e.g. distance between the vehicle and the pick-up location, driver's points, etc. Server 120 may be configured to store the plurality of bidding requests in a bidding request database. The plurality of vehicles 140 may decline at least one of the plurality of vehicle booking requests by submitting a decline instruction to the server 120 via the vehicular device 142 in the vehicle 140.

Even though the server 120 is configured not to transmit the plurality of vehicle booking requests to the plurality of excluded vehicles, the server 120 may be configured to transmit advance vehicle booking requests to the plurality of excluded vehicles. Advance vehicle booking requests may be vehicle booking requests that are made before the pick-up time of the user. Advance booking requests may be made between 1 hour and 7 days before the pick-up time.

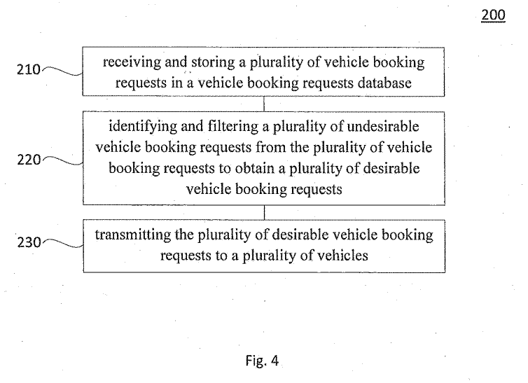

FIG. 4 shows an exemplary method 200 for booking a vehicle or a vehicle booking method. Method 200 may include receiving and storing a plurality of vehicle booking requests in a vehicle booking requests database 122 in 210, identifying and filtering a plurality of undesirable vehicle booking requests from the plurality of vehicle booking requests to obtain a plurality of desirable vehicle booking requests in 220, and transmitting the plurality of desirable vehicle booking requests to a plurality of vehicles in 230.

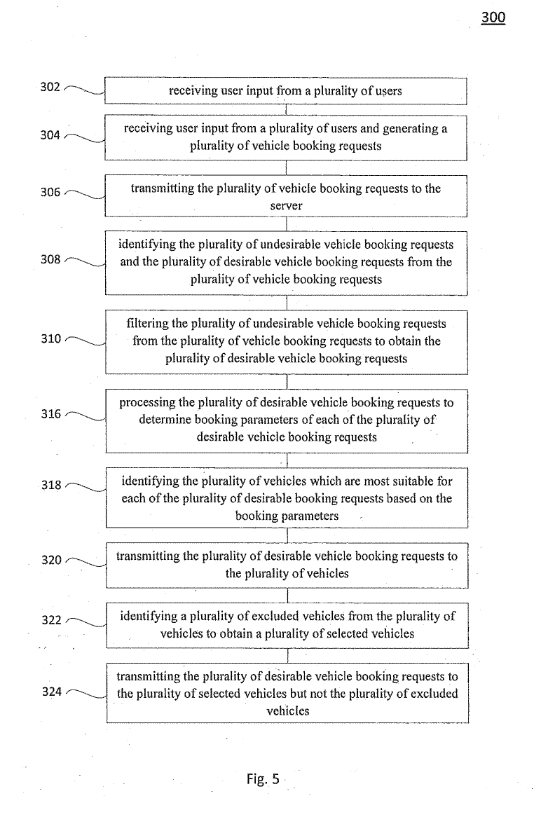

FIG. 5 shows an exemplary method 300 for booking a vehicle. Method 300 may include receiving user input from a plurality of users in 302 and generating a plurality of vehicle booking requests in 304. Thereafter, the plurality of vehicle booking requests may be transmitted to the server 120 in 306. Method 300 may further include identifying the plurality of undesirable vehicle booking requests and the plurality of desirable vehicle booking requests from the plurality of vehicle booking requests in 308 and filtering the plurality of undesirable vehicle booking requests from the plurality of vehicle booking requests to obtain the plurality of desirable vehicle booking requests in 310. Method 300 may include processing the plurality of desirable vehicle booking requests to determine booking parameters of each of the plurality of desirable vehicle booking requests in 316. Further, the method 300 may include identifying the plurality of vehicles 140 which are most suitable for each of the plurality of desirable booking requests based on the booking parameters in 318 and transmitting the plurality of desirable vehicle booking requests to the plurality of vehicles 140 in 320.

Method 300 may include identifying a plurality of excluded vehicles from the plurality of vehicles to obtain a plurality of selected vehicles in 322, and transmitting the plurality of desirable vehicle booking requests to the plurality of selected vehicles but not the plurality of excluded vehicles in 324.

Referring to FIG. 6, identifying in 308 may include identifying a duplicate vehicle booking request of an original vehicle booking request in 312.

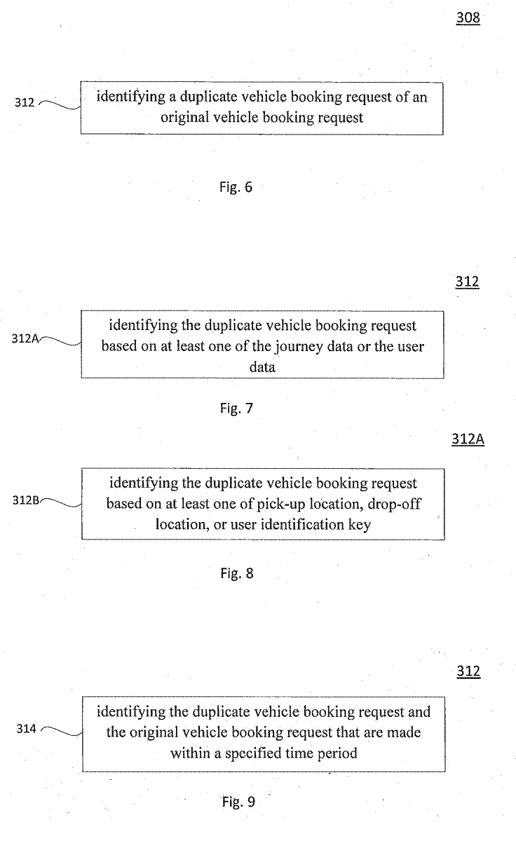

As shown in FIG. 7, identifying in 312 may include identifying the duplicate vehicle booking request based on at least one of the journey data or the user data in 312A.

Referring to FIG. 8, identifying in 312A may include identifying the duplicate vehicle booking request based on at least one of pick-up location, drop-off location, or user identification key 312B.

As shown in FIG. 9, identifying in 312 may include identifying the duplicate vehicle booking request and the original vehicle booking request that are made within a specified time period in 314.

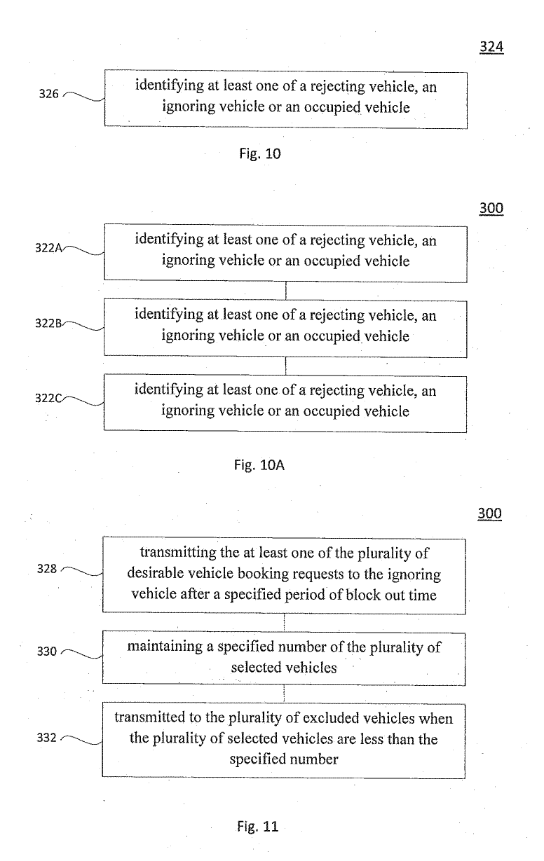

Referring to FIG. 10, identifying in 324 may include identifying at least one of a rejecting vehicle, an ignoring vehicle or an occupied vehicle in 326.

Referring to FIG. 10A, identifying in 322 may further include filtering the rejecting vehicle from the plurality of vehicles in 322A, filtering the plurality of occupied vehicles from the plurality of vehicles in 322B, and filtering the plurality of ignoring vehicles from the plurality of vehicles in 322C to obtain the plurality of selected vehicles.

Referring to FIG. 11, the method 300 may further include transmitting the at least one of the plurality of desirable vehicle booking requests to the ignoring vehicle after a specified period of block out time in 328. Method 300 may further include maintaining a specified number of the plurality of selected vehicles in 330 such that the plurality of desirable vehicle booking requests are transmitted to the plurality of excluded vehicles when the plurality of selected vehicles are less than the specified number in 332.

1. A vehicle booking system comprising:
a server configured to communicate with a plurality of vehicles, wherein the server is configured to receive and store a plurality of vehicle booking requests in a vehicle booking requests database; and
wherein the server is configured to identify and filter a plurality of undesirable vehicle booking requests from the plurality of vehicle booking requests to obtain a plurality of desirable vehicle booking requests and transmit the plurality of desirable vehicle booking requests to the plurality of vehicles.

2. The vehicle booking system of claim 1, wherein the plurality of undesirable vehicle booking requests are identified based on booking request data of the plurality of vehicle booking requests.

3. The vehicle booking system of claim 2, wherein the booking request data comprises journey data, wherein the plurality of undesirable vehicle booking requests are identified based on the journey data of the plurality of vehicle booking requests.

4. The vehicle booking system of claim 3, wherein the journey data comprises pick-up location and/or drop-off location of a user.

5. The vehicle booking system of claim any one of claims 2 to 4, wherein the booking request data comprises user data, wherein the plurality of undesirable vehicle booking requests are identified based on user data of the plurality of vehicle booking requests.

6. The vehicle booking system of claim 5, wherein the user data of each of the plurality of vehicle booking requests comprises a user identification key.

7. The vehicle booking system of any one of claims 1 to 6, wherein the plurality of undesirable vehicle booking requests comprise a duplicate vehicle booking request of an original vehicle booking request.

8. The vehicle booking system of claim 7, wherein the duplicate vehicle booking request comprises the same pick-up location and/or drop-off location as the original vehicle booking request.

9. The vehicle booking system of claim 7 or 8, wherein the duplicate vehicle booking request comprises the same user identification key as the original vehicle booking request.

10. The vehicle booking system of any one of claims 7 to 9, wherein the duplicate vehicle booking request and the original vehicle booking request are made within a specified time period.

11. The vehicle booking system of any one of claims 1 to 10, wherein the server is configured to identify a plurality of excluded vehicles from the plurality of vehicles to obtain a plurality of selected vehicles, wherein the plurality of desirable vehicle booking requests are transmitted to the plurality of selected vehicles but not the plurality of excluded vehicles.

12. The vehicle booking system of claim 11, wherein the plurality of excluded vehicles comprises a rejecting vehicle, wherein the rejecting vehicle rejects at least one of the plurality of desirable vehicle booking requests, wherein the rejecting vehicle is excluded from receiving the at least one of the plurality of desirable vehicle booking requests.

13. The vehicle booking system of any one of claims 12 to 13, wherein the plurality of excluded vehicles comprise an ignoring vehicle, wherein the ignoring vehicle ignores at least one of the plurality of desirable vehicle booking requests, wherein the ignoring vehicle is excluded from receiving the at least one of the plurality of desirable vehicle booking requests.

14. The vehicle booking system of claim 13, wherein the ignoring vehicle is considered to ignore the at least one of the plurality of desirable booking requests when the ignoring vehicle ignores the at least one of the plurality of desirable booking requests beyond a specified time period from the time when the at least one of the plurality of desirable booking requests are transmitted to the ignoring vehicle.

15. The vehicle booking system of claim 13 or 14, wherein the transmission of the at least one of the plurality of desirable booking requests to the ignoring vehicle is terminated when the ignoring vehicle ignores the plurality of desirable booking requests beyond a specified number of times.

16. The vehicle booking system of any one of claims 13 to 15, wherein ignoring the plurality of desirable booking requests includes not submitting the bidding request or decline instruction for the at least one of the plurality of desirable booking requests.

17. The vehicle booking system of any one of claims 13 to 16, wherein the server transmits the at least one of the plurality of desirable vehicle booking requests to the ignoring vehicle after a specified period of block out time.

18. The vehicle booking system of any one of claims 11 to 17, wherein the plurality of excluded vehicles comprises an occupied vehicle, wherein the occupied vehicle comprises a vehicle having a passenger on board.

19. The vehicle booking system of claim 18, wherein the occupied vehicle is occupied when a distance travelled by the occupied vehicle from a pick-up location of the passenger is shorter than a specified proportion of the calculated distance between the pick-up location and a drop-off location.

20. The vehicle booking system of claim 18 or 21, wherein the occupied vehicle is occupied when a time period that the passenger is on board the occupied vehicle is shorter than a specified proportion of estimated travel time to travel from the pick-up location to the drop-off location.

21. The vehicle booking system of any one of claims 11 to 20, wherein the server is configured to maintain a specified number of the plurality of selected vehicles, wherein the server is configured to transmit the plurality of desirable vehicle booking requests to the plurality of excluded vehicles when the plurality of selected vehicles are less than the specified number.

22. A method for booking a vehicle, the method comprising:
receiving and storing a plurality of vehicle booking requests in a vehicle booking requests database;
identifying and filtering a plurality of undesirable vehicle booking requests from the plurality of vehicle booking requests to obtain a plurality of desirable vehicle booking requests; and
transmitting the plurality of desirable vehicle booking requests to a plurality of vehicles.

23. The method of claim 22, wherein the plurality of undesirable vehicle booking requests are identified based on booking request data of the plurality of vehicle booking requests.

24. The method of claim 23, wherein the booking request data comprises journey data, wherein the plurality of undesirable vehicle booking requests are identified based on the journey data of the plurality of vehicle booking requests.

25. The method of claim 24, wherein the journey data comprises pick-up location and/or drop-off location.

26. The method of any one of claims 23 to 25, wherein the booking request data comprises user data, wherein the plurality of undesirable vehicle booking requests are identified based on user data of the plurality of vehicle booking requests.

27. The method of claim 26, wherein the user data of each of the plurality of vehicle booking requests comprises a user identification key.

28. The method of any one of claims 24 to 27, wherein the plurality of undesirable vehicle booking requests comprise a duplicate vehicle booking request of an original vehicle booking request.

29. The method of any one of claims 22 to 28, wherein the plurality of undesirable vehicle booking requests comprise a duplicate vehicle booking request of an original vehicle booking request.

30. The method of claim 29, wherein the duplicate vehicle booking request comprises the same pick-up location and/or drop-off location as the original vehicle booking request.

31. The method of claim 29 or 30, wherein the duplicate vehicle booking request comprises the same user identification key as the original vehicle booking request.

32. The method of any one of claims 28 to 31, wherein the duplicate vehicle booking request and the original vehicle booking request are made within a specified time period.

33. The method of any one of claims 22 to 32, further comprising identifying a plurality of excluded vehicles from the plurality of vehicles to obtain a plurality of selected vehicles, wherein the plurality of desirable vehicle booking requests are transmitted to the plurality of selected vehicles but not the plurality of excluded vehicles.

34. The method of claim 33, wherein the plurality of excluded vehicles comprises a rejecting vehicle, wherein the rejecting vehicle rejects at least one of the plurality of desirable vehicle booking requests, wherein the rejecting vehicle is excluded from receiving the at least one of the plurality of desirable vehicle booking requests.

35. The method of claim 33 or 34, wherein the plurality of excluded vehicles comprise an ignoring vehicle, wherein the ignoring vehicle ignores the plurality of desirable booking requests, wherein the ignoring vehicle is excluded from receiving the at least one of the plurality of desirable vehicle booking requests.

36. The method of claim 35, wherein the ignoring vehicle is considered to ignore the at least one of the plurality of desirable booking requests when the ignoring vehicle ignores the at least one of the plurality of desirable booking requests beyond a specified time period the time from when the at least one of the plurality of desirable booking requests are transmitted to the ignoring vehicle.

37. The method of claim 35 or 36, wherein the transmission of the at least one of the plurality of desirable booking requests to the ignoring vehicle is terminated when the ignoring vehicle ignores the plurality of desirable booking requests beyond a specified number of times.

38. The method of any one of claims 35 to 37, wherein ignoring the plurality of desirable booking requests includes not submitting the bidding request for the at least one of the plurality of desirable booking requests.

39. The method of any one of claims 35 to 38, further comprising transmitting the at least one of the plurality of desirable vehicle booking requests to the ignoring vehicle after a specified period of block out time.

40. The method of any one of claims 33 to 39, wherein the plurality of excluded vehicles comprises an occupied vehicle, wherein the occupied vehicle comprises a vehicle having a passenger on board.

41. The method of claim 40, wherein the occupied vehicle is occupied when a distance travelled by the occupied vehicle from a pick-up location of the passenger is shorter than a specified proportion of the calculated distance between the pick-up location and a drop-off location of the passenger.

42. The method of claim 40 or 41, wherein the occupied vehicle is occupied when a time period that the passenger is on board the occupied vehicle is shorter than a specified proportion of estimated travel time to travel from the pick-up location to the drop-off location of the passenger.

43. The method of any one of claims 33 to 42, further comprising maintaining a specified number of the plurality of selected vehicles, wherein the plurality of desirable vehicle booking requests are transmitted to the plurality of excluded vehicles when the plurality of selected vehicles are less than the specified number.
